(19) United States
(12) Patent Application Publication
(10) Pub. No.: US 2026/0365113 A1
(43) Pub. Date: Nov. 19, 2026

(54) Un known

(71) Applicant: LOKHEN S.R.L., Altamura (IT)

(72) Inventors: Daniele BARATTINI, Altamura (IT); Luca Oronzo GRECO, Altamura (IT)

(21) Appl. No.: 19/570,569

(22) Filed: Mar. 18, 2026

(30) Foreign Application Priority Data
Mar. 20, 2025 (IT) 102025000005745

(51) Int. Cl. B60R 9/048

(52) U.S. Cl. CPC B60R 9/0485

(57) ABSTRACT

A ladder clamping device for vehicles has an elongated main body, parallel to a longitudinal direction, and having a lower wall facing a ladder, a ratchet mechanism having a spool rotatable about a rotation axis perpendicular to the longitudinal direction and provided with an external toothing and a return spring, in which the ratchet mechanism is mechanically connected to an actuation lever protruding from the main body and configured to actuate a rotation of the spool, overcoming a resistance of the return spring. Flexible lockers, fastened to the spool at a first end and provided with a locking buckle and/or a locking hook, at a second end, opposite to the first end, are at least partially wound on the spool to wind and unwind in agreement with a rotation direction of the spool. The return spring biases the spool in rotation according to a winding direction of the flexible lockers.

### CROSS-REFERENCE TO RELATED APPLICATION

This application claims priority to Italian Patent Application No. 102025000005745 filed Mar. 20, 2025, the entire contents of which is hereby incorporated in its entirety by reference.

### FIELD OF APPLICATION

The present invention relates to a ladder clamping device for vehicles, adapted to secure/release a stepladder on a roof rack mounted on the roof of vehicles, and the relative assembly method.

### BACKGROUND ART

The prior art has several solutions of ladder clamping devices that serve to secure and release a ladder previously resting horizontally on at least two bars of a roof rack mounted on the roof of a vehicle, conventionally an automobile or an industrial vehicle such as, for example, a van.

Such known devices conventionally comprise a main body, adapted to come into contact with the ladder, and a metal rod, vertical and perpendicular to the body and to the ladder to be secured, which ends with a rigid hook. The rigid hook extends beyond the ladder and is configured to hook onto a portion of the roof rack bar; thereby, the ladder is firmly secured between the roof rack and the ladder clamping device. Securing the ladder requires the use of at least two ladder clamping devices, adapted to ensure the securing on the two opposite ends of the ladder itself.

A mechanism allowing the metal rod to be moved vertically so as to bring the hook into such a position as to engage the roof rack bar is required in order to firmly secure the ladder. Obviously, the ladder clamping device must be configured to adapt to roof racks and ladders having different sizes and shapes.

The mechanisms of the known type comprise levers, wheels or wing nuts which allow adjusting the vertical position of the metal rod and the relative securing.

The known solutions are not free from drawbacks.

In fact, rigid metal rods do not guarantee compatibility with all possible types of ladders and with all types of roof rack bars on the market. Further, the metal rod on the roof of the vehicle generates noise and aerodynamic turbulence. Further, the shape of the rigid metal hook allows adherence to a limited part of the roof rack bar.

The very presence of the metal rod constitutes a rigid body that protrudes from the overall outline and therefore implies safety risks.

Further, it is necessary for the device to be relatively easy and quick to assemble so as to reduce the overall cost thereof. The known solutions, albeit secure from the standpoint of securing the ladder on the roof of the vehicle, result in relatively high manufacturing and assembly costs.

### SUMMARY OF THE INVENTION

Therefore, the need is felt to solve the drawbacks and limitations mentioned with reference to the prior art.

In other words, there is a need to provide a ladder clamping device that, on the one hand, is safe, versatile, and not bulky, and that, on the other hand, is also quick, practical, and affordable to assemble.

Such a need is met by a ladder clamping device and by a method of assembling a ladder clamping as described and claimed herein.

### DESCRIPTION OF THE DRAWINGS

Further features and advantages of the present invention will be more comprehensible from the following description of preferred, non-limiting embodiments thereof, in which:

FIG. 1 shows a perspective view, in an assembled configuration, of a ladder clamping device according to a possible embodiment of the present invention;

FIG. 2 shows a front view of the ladder clamping device of FIG. 1;

FIG. 3 shows a side view of the ladder clamping device of FIG. 1;

FIGS. 4-5 show perspective views, in longitudinal section, from different angles, of the ladder clamping device of FIG. 1;

FIGS. 6-7 show exploded views, from different angles, of the ladder clamping device of FIG. 1;

FIGS. 8-10 show perspective views of a sequence for securing a ladder clamping device according to the present invention;

FIG. 11 shows views of applications of the ladder clamping device of the present invention, on different types of ladders;

FIG. 12 shows views of flexible locking means applied to a roof rack bar according to a possible embodiment of the present invention;

FIG. 13 shows views of flexible locking means applied to a roof rack bar according to a further possible embodiment of the present invention;

FIG. 14 shows flexible locking means, for example a strap, applied to a roof rack bar;

FIG. 15 shows a perspective view, in an assembled and open configuration, of a ladder clamping device according to a further possible embodiment of the present invention;

FIG. 16 shows a perspective view, in an assembled and semi-open configuration, of the ladder clamping device of FIG. 15;

FIG. 17a shows a perspective view, in an assembled and closed configuration, of the ladder clamping device of FIG. 15;

FIG. 17b shows a sectional view of the ladder clamping device of FIG. 15, at the lock; and

FIGS. 18-27 show perspective views of an assembly sequence of a ladder clamping device according to the present invention.

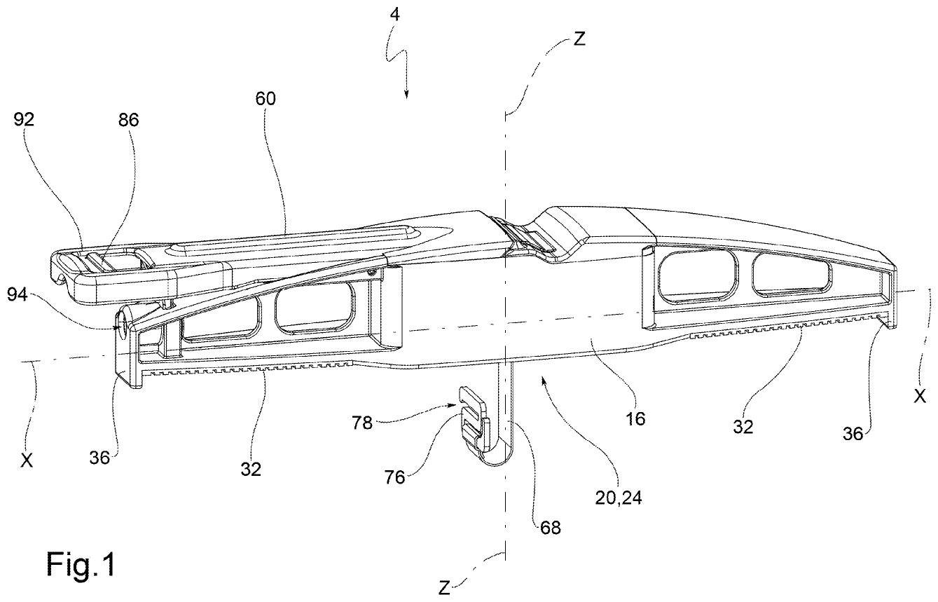

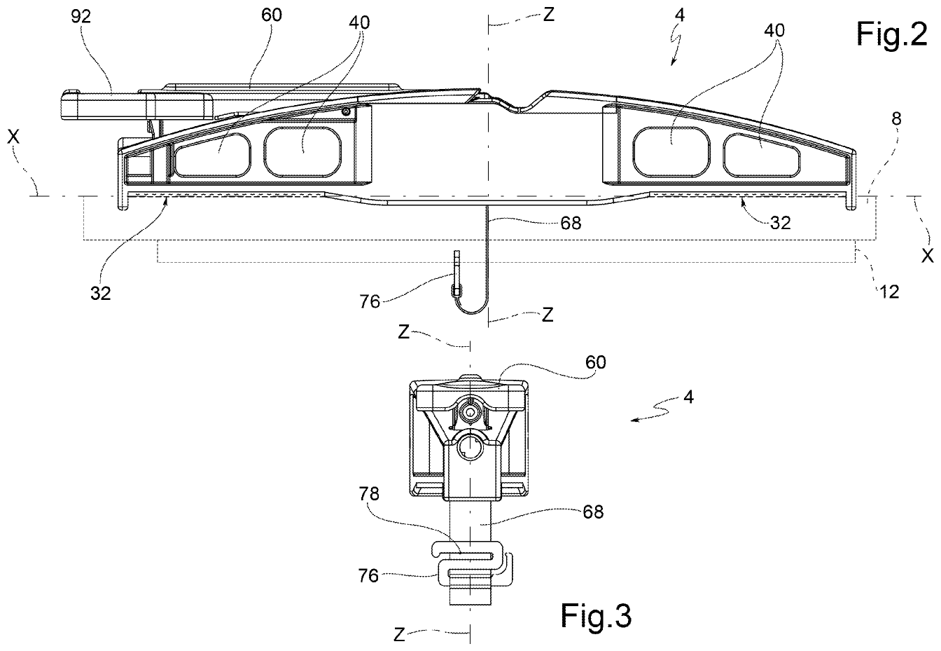

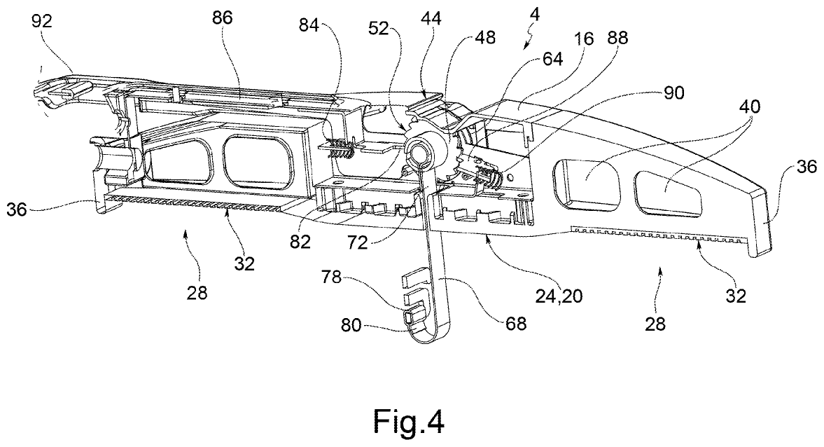

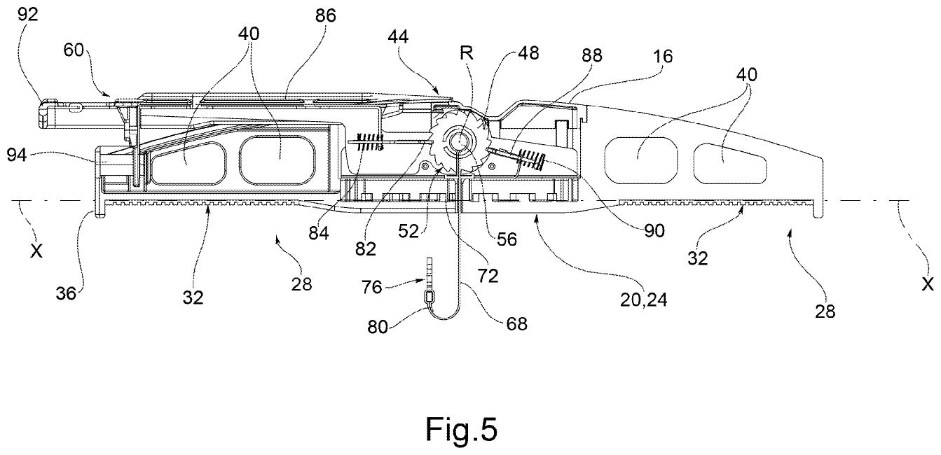

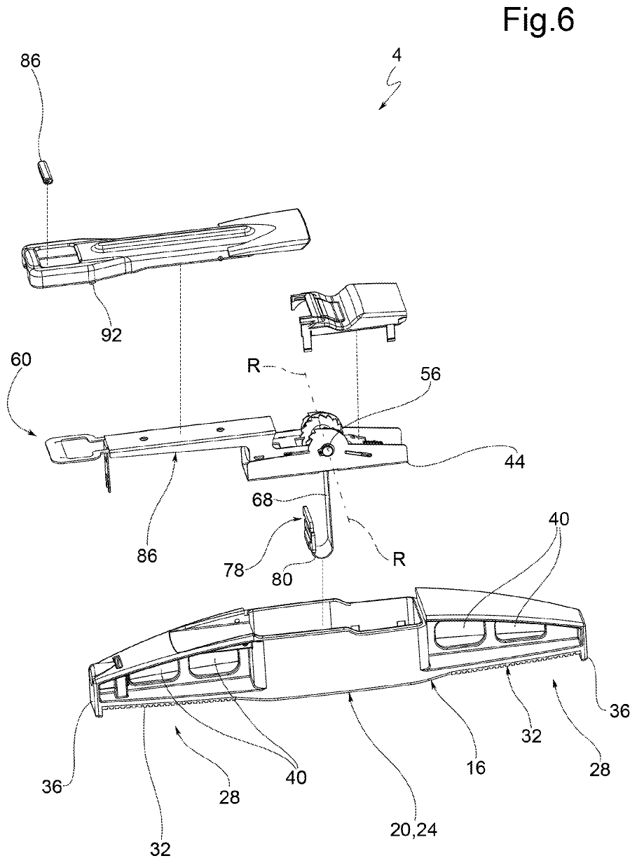

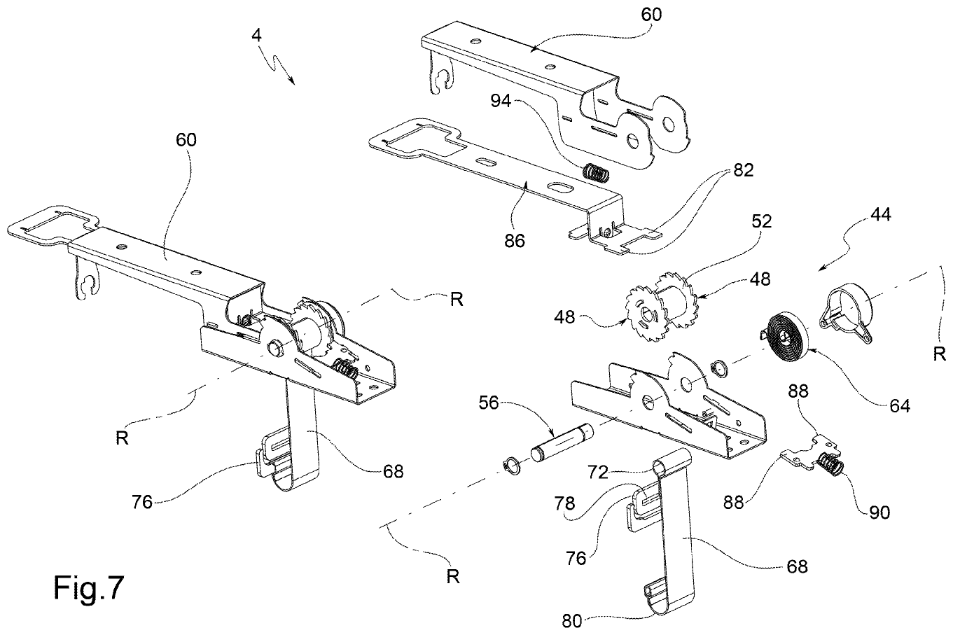

The elements or parts of elements common to the embodiments described below will be indicated by the same reference numerals.

### DETAILED DESCRIPTION

With reference to the figures, reference numeral 4 globally indicates an overall diagrammatic view of a ladder clamping device for vehicles according to the present invention, where a ladder 8 is previously resting on a roof rack 12 of the vehicle, where the roof rack 12 conventionally consists of a structure comprising a plurality of bars 14 suitably constrained to one another. The bars 14 may have a circular, rectangular, or elliptical section, or a regular or irregular polygonal section, or a curvilinear section in general. The ladder 8 may also be a stepladder and is preferably of the rung type. For the purposes of the present invention, the size, material, or type of stepladder is not relevant.

For the purposes of the present invention, neither the type of vehicle on which the ladder is mounted nor the type of roof rack previously anchored to the roof of the vehicle is relevant.

The ladder clamping device 4 for vehicles comprises an elongated main body 16, parallel to a longitudinal direction X-X, the elongated main body 16 being provided with a lower wall 20 facing an associable ladder 8 to be secured.

According to an embodiment, the lower wall 20 comprises a central base 24 and a pair of lateral recesses 28, on opposite sides of the central base 24, along the longitudinal direction X-X. The lateral recesses 28 are shaped to come into contact with a leg of the ladder 8 and secure it against the bars 14 of the roof rack 12.

In general, the central base 24 consists of a stiffening element of the ladder clamping device 4, capable of supporting the tension of the strap element of the device itself, as described in greater detail below.

The lateral recesses 28 are retracted with respect to the central base 24 along a vertical direction Z-Z, perpendicular to the longitudinal direction X-X. Each lateral recess 28 in effect creates a seat for at least partially housing a portion of the ladder 8 to be secured.

According to an embodiment, the lateral recesses 28 are provided with a lower knurl 32 and/or lateral containment strips 36. The lower knurl 32 may be replaced or supplemented by any surface treatment or processing adapted to increase the grip with the ladder 8.

The lower knurl 32 increases the grip between the ladder clamping device 4 and the associable ladder 8.

According to a further embodiment, a plate or co-molded portion configured to increase the grip with the associable ladder 8 is associated with the lateral recesses 28.

The lateral containment strips 36 are useful to improve the grip of the ladder clamping device 4 on ladder 8, in the lateral direction.

The elongated main body 16 may be provided with lightening portions 40 in the form of windows or through openings through the elongated main body 16, at the lateral recesses 28. In addition to reducing the overall mass of the ladder clamping device 4, the lightening portions 40 also reduce the front surface of the ladder clamping device 4 impacting with the air: thereby, positive effects are obtained for the overall aerodynamic resistance of the ladder clamping device 4 and for the relative aerodynamic noise/rustling generated when the vehicle is travelling.

According to an embodiment, the central base 24 has a through opening 25 having a slot 26 and a central enlargement 27; further, a removable cap 29, which is at least partially counter-shaped with respect to the through opening 25 so as to reduce the passage lumen overall thereof, is associated with the central base 24. For example, the removable cap 29 is a plate preassembled on the flexible locking means 68. According to an embodiment, the removable cap 29 is made of two shells 30 that are separable from each other, for example, according to a shape coupling. Once associated with each other, the shells 30 define a through channel 31. The shells preferably comprise an upper edge 33 defining an undercut with respect to the through opening 25, according to a direction of extraction of the shells 30 from inside of the elongated main body 16 downwards, i.e. towards the associable ladder 8.

The ladder clamping device 4 further comprises a ratchet mechanism 44, housed in the elongated main body 16 and comprising a spool 48 rotatable about a rotation axis R-R perpendicular to the longitudinal direction X-X.

The spool 48 is provided with an external toothing 52 and rotates about a pin 56 defining the rotation axis R-R.

Further, the spool 48 is provided with a return spring 64. For example, the return spring 64 is a spiral spring, coaxial to the spool 48.

The ratchet mechanism 44 is mechanically connected to an actuation lever 60 protruding from the elongated main body 16 and parallel to the longitudinal direction X-X; in particular, the actuation lever 60 is configured to actuate the rotation of the spool 48, thus overcoming the resistance of the return spring 64.

The ladder clamping device 4 further comprises flexible locking means 68 for the ladder 8, fastened to the spool 48 at a first end 72 thereof and provided with a locking buckle and/or a locking hook 76 at a second end 80, opposite to the first end 72. The flexible locking means 68 may comprise a strap, a rope, a cable, a chain or similar elements that are at least partially flexible and windable around the spool 48.

According to an embodiment, the locking buckle 76 is provided with at least one laterally open slit 78.

The locking hook 76 is preferably provided with a rotatable eyelet 77.

The flexible locking means 68 are at least partially wound on the spool 48 so as to wind and unwind in agreement with the rotation direction of the spool 48; the return spring 64 biases, i.e. returns, the spool 48 in rotation according to a winding direction of the flexible locking means 68.

According to an embodiment, the rotatable spool 48 is associated with at least a first stop 82, normally engaged with the external toothing 52. The first stop 82 is shaped so that, when in the engagement condition, it makes the actuation lever 60 integral with the spool 48 rotating in a winding direction of the flexible locking means 68. At the same time, the first stop 82 allows the rotation of the spool 48 in the winding direction of the flexible locking means 68.

Preferably, the first stop 82 is biased into abutment against the external toothing 52 by a first spring 84.

According to an embodiment, the actuation lever 60 is provided with a locking/unlocking element 86, operatively connected to the first stop 82 so as to allow the transition of the first stop 82 from an engagement condition to a disengagement condition with respect to the external toothing 52.

For example, the locking/unlocking element 86 is a slider that is movable so as to allow the disengagement of the first stop 82 from the external toothing 52.

For example, the movable slider is part of a plate that is integral with the first stop 82.

According to an embodiment, the rotatable spool 48 is provided with a second stop 88 always engaged with the external toothing 52, in agreement with the first stop 82.

For example, the second stop 88 is biased into abutment against the external toothing 52 by a second spring 90.

Preferably, the second stop 88 is arranged in a position that is diametrically opposite to the first stop 82, with respect to the rotation axis R-R of the spool 48.

For example, the actuation lever 60 is provided with a handle 92 that is cantilevered, with respect to the elongated main body 16, along the longitudinal direction X-X.

According to an embodiment, the locking buckle or locking hook 76 is shaped so as to be able to pass through the through opening 25 of the central base 24 of the elongated main body 16, and so as not to be able to pass through the through channel 31 defined by the shells 30.

Instead, the through channel 31 is configured so as to allow the passage through and the sliding of the flexible locking means 68.

According to an embodiment, the actuation lever 60 is provided with a lock 94 for locking the actuation lever 60 on the elongated main body 16. The purpose of the lock 94 is to increase security and prevent the theft of the ladder 8.

According to an advantageous embodiment, the lock 94 is arranged on a lateral end 95 of the elongated main body 16 so as to be easily accessible by a user from the outside. Advantageously, the actuation lever 60 is integral with a closing portion 96, for example, fork-shaped, positioned and shaped so that the closing portion 96 is aligned with the lock 94, in a lowered actuation lever 60 configuration.

The mutual positioning of the closing portion 96 and lock 94 advantageously allows the lock to be easily reached by a hand and therefore, the actuation lever 60 to be locked/unlocked. Further, by virtue of the presence of the closing portion 96 directly on the actuation lever 60, towards handle 92, the use of mechanical returns on the central part of the elongated main body 16 may be avoided, as occurs in some solutions of the prior art.

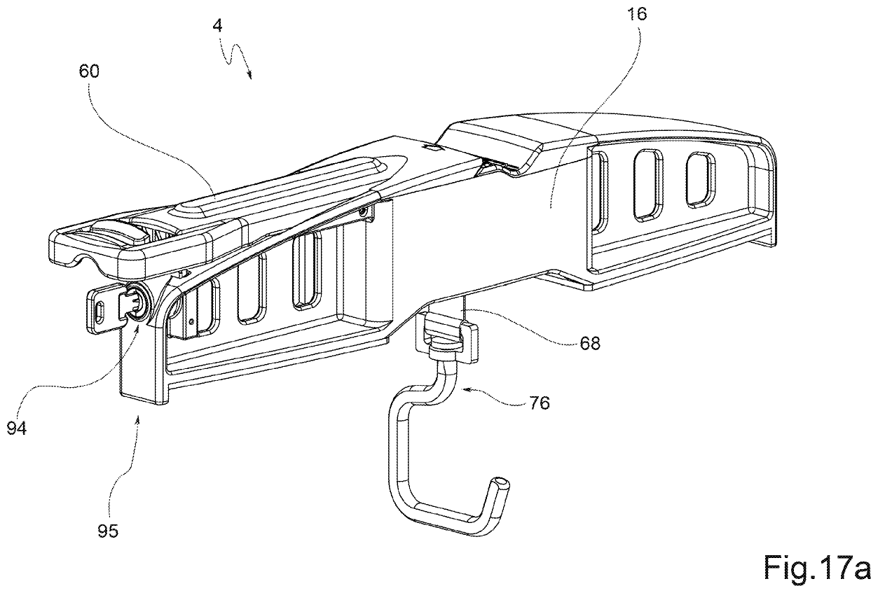

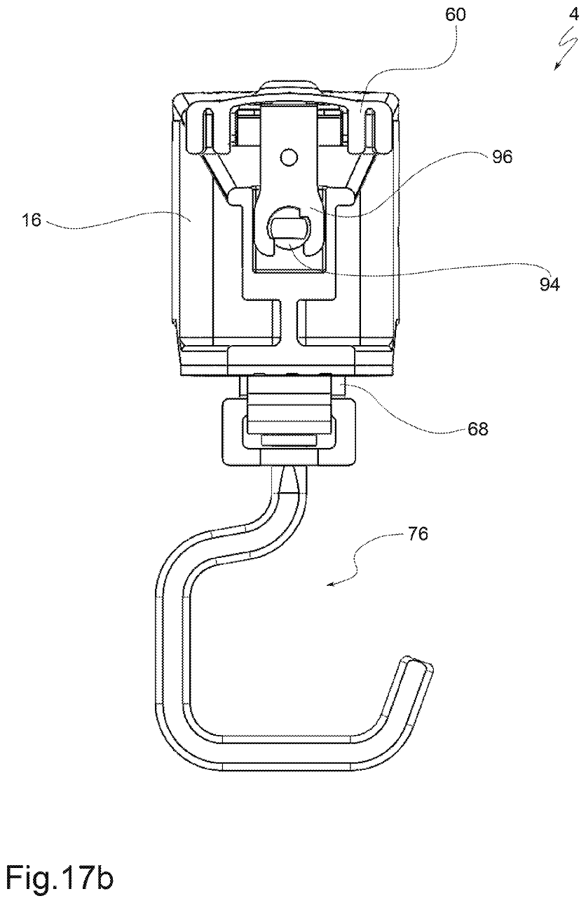

The lock 94 is configured so as to lock the closing portion 96, for example as undercut (FIG. 17b), so as to prevent the actuation lever 60 from being lifted, when arranged in the securing or closing configuration. Preferably, the elongated main body 16, at an upper wall 97 thereof, provides a seat 98 adapted to at least partially house the closing portion 96 when the actuation lever 60 is lowered to the closing position.

The operation of a ladder-locking device according to the present invention will now be described.

In particular, in order to secure the ladder 8, the latter is arranged in advance on at least one bar 14 of the roof rack 12 previously anchored to the roof of the vehicle.

Then the elongated main body 16 of the ladder clamping device 4 is rested on the ladder 8, and the ladder 8 is crossed by the flexible locking means 68, taking care to fasten the locking buckle 76 at a point on the bar 14 of the frame of the roof rack 12. For example, it is possible to surround the bar 14 of the frame of the roof rack 12 with the flexible locking means 68 and secure the locking buckle 76 onto the same flexible locking means 68, which may be inserted into the slit 78 of the flexible locking means 68. Alternatively, it is possible to fasten the locking hook 76 directly on a bar 14 of the frame of the roof rack 12.

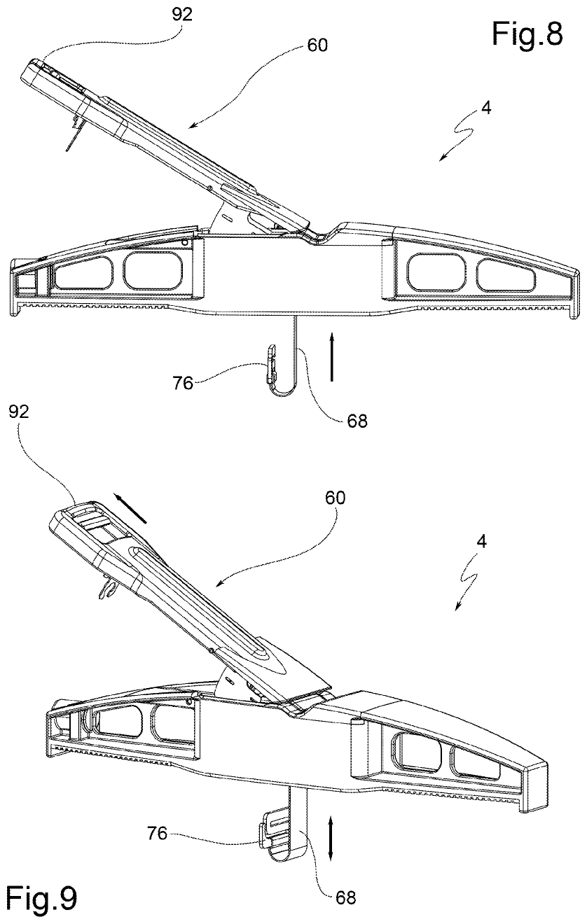

At this point, the tensioning sequence of the flexible locking means 68 for solidly anchoring stepladder 8 to the roof rack 12 may begin, as illustrated in FIGS. 8 to 10 (where the stepladder and the bar have been omitted).

In particular, the actuation lever 60 is rotated upwards, i.e., away from the elongated main body 16, for example by about 30°, preferably via a handle 92, so as to allow the rotation of the spool 48 in a winding direction, and thus a traction direction of the flexible locking means 68 (FIG. 8).

The locking/unlocking element 86 is actuated so as to disengage the actuation lever 60 from the spool 48, which is idle, i.e. free to rotate under the action of the return spring 64. Thereby, the flexible locking means 68 will tend to wind onto the spool 48. Under this condition, the operator may also unwind the return spring 64 so as to adjust the length of the flexible locking means 68 with respect to the roof rack 12 (FIG. 9).

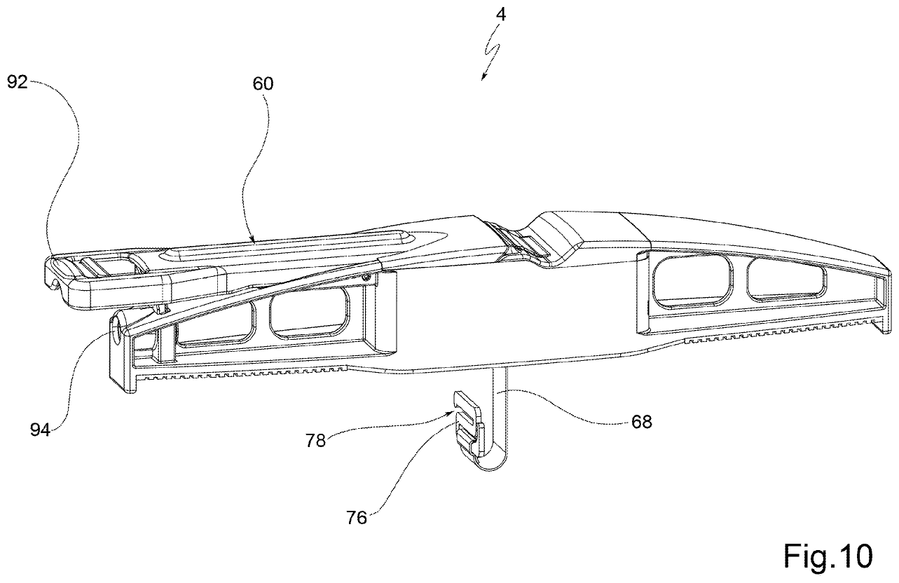

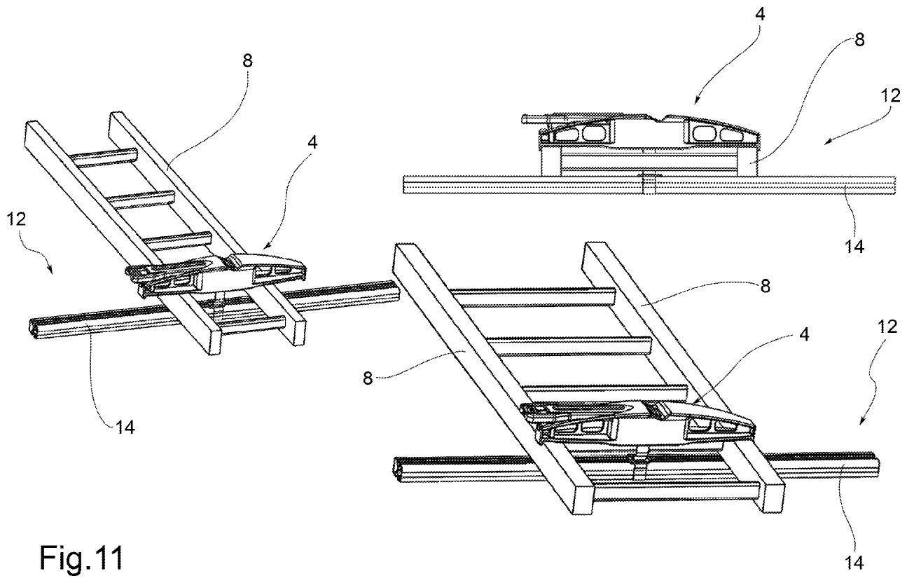

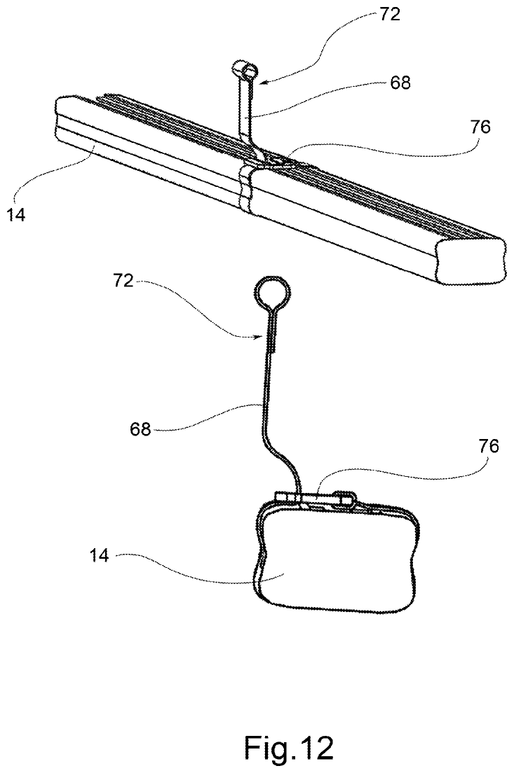

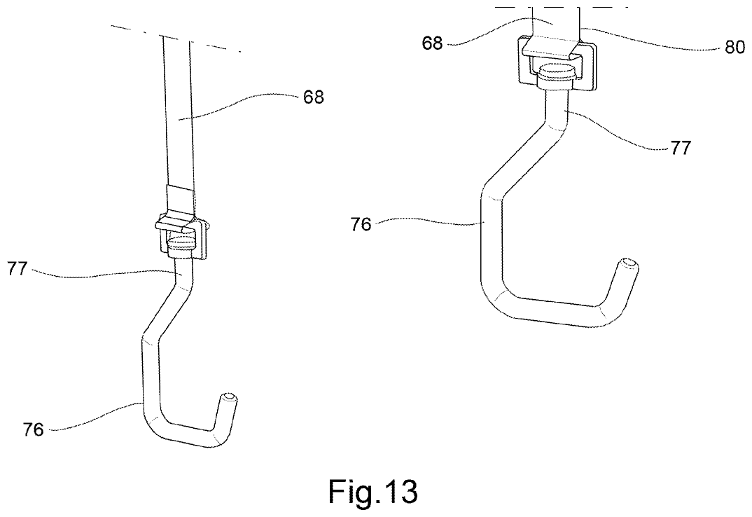

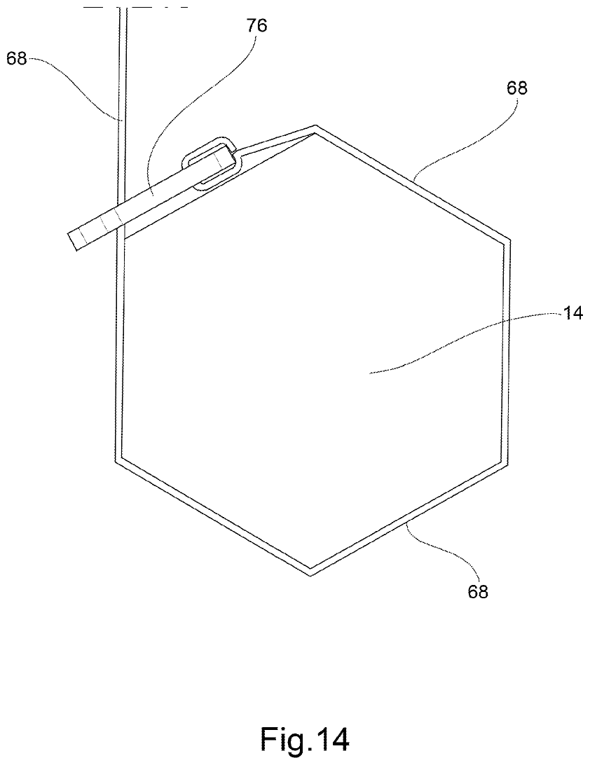

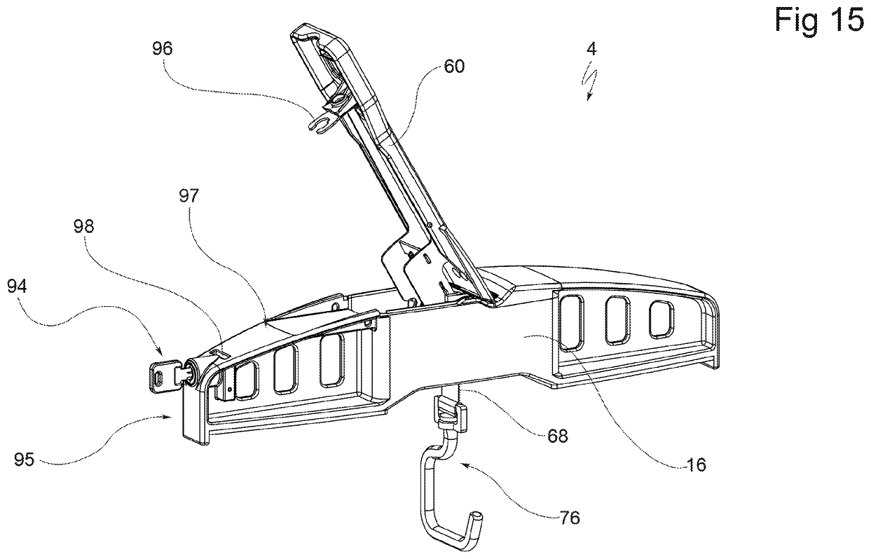

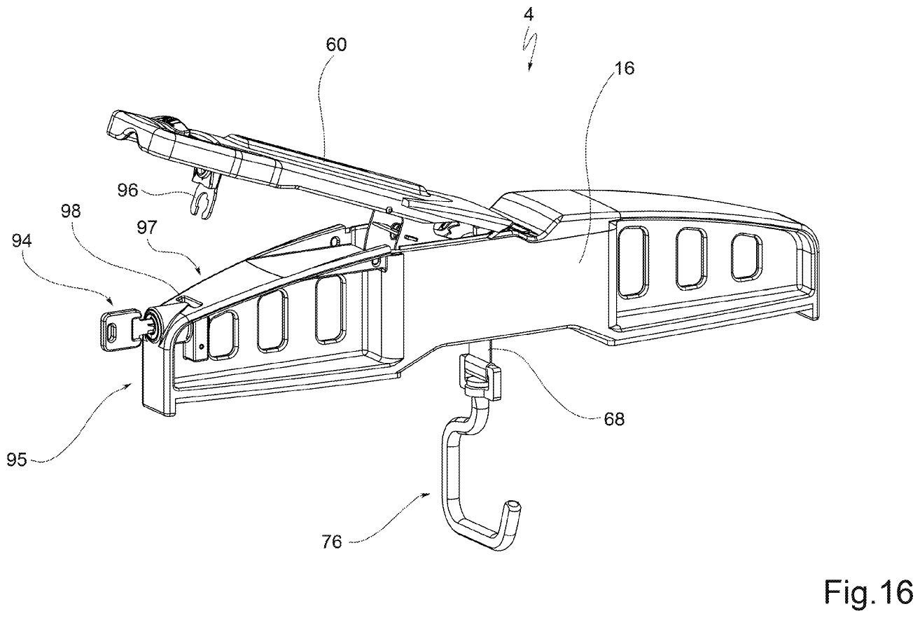

Finally, the locking/unlocking element 86 is actuated again to return it to the lowered or horizontal position (FIG. 10).

When it is in the closing configuration, i.e. with the actuation lever 60 lowered, the closing portion 96 is inserted into the seat 98 formed on the upper wall 97, and may therefore be locked by acting on lock 94.

The method of assembling a ladder clamping device according to the present invention is also described.

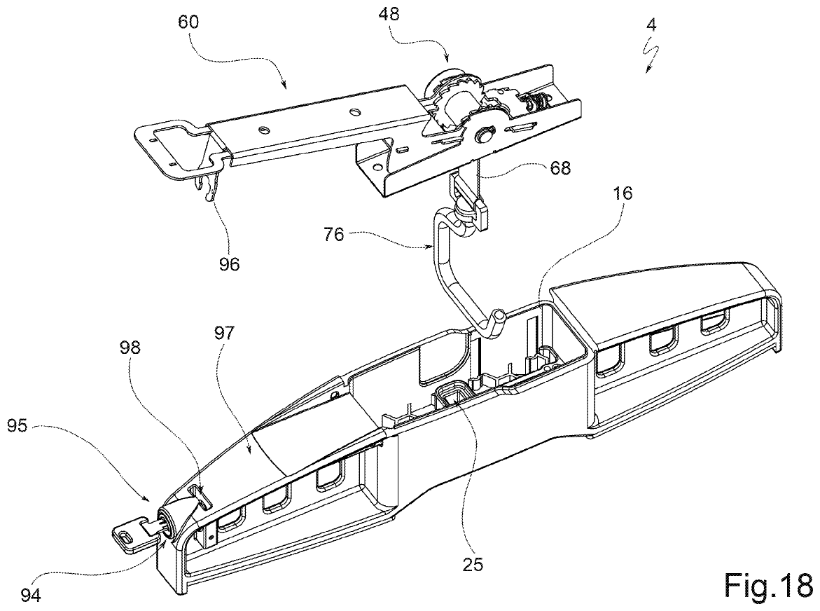

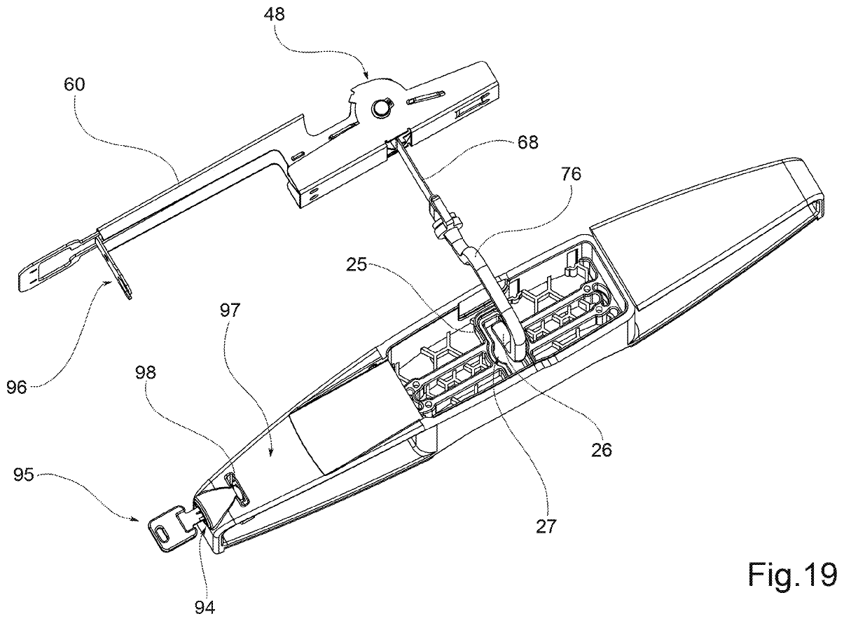

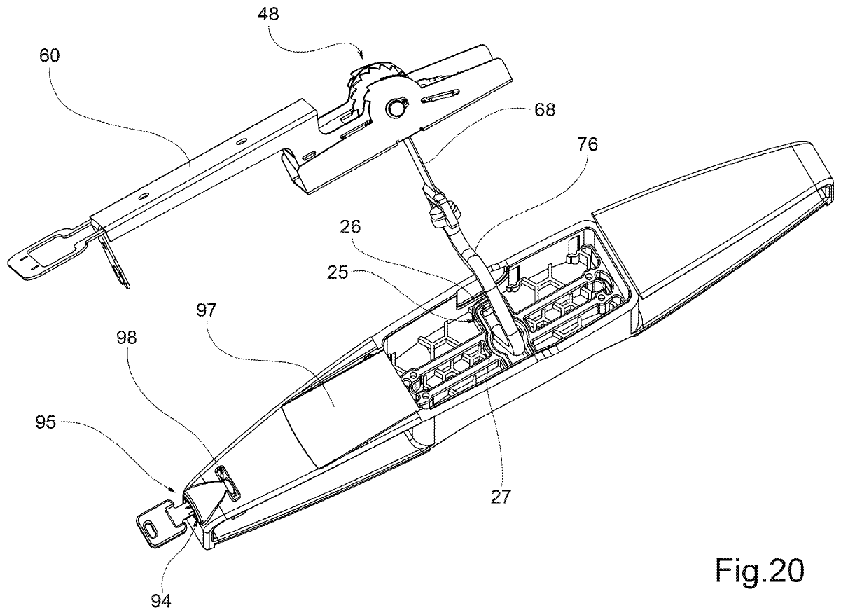

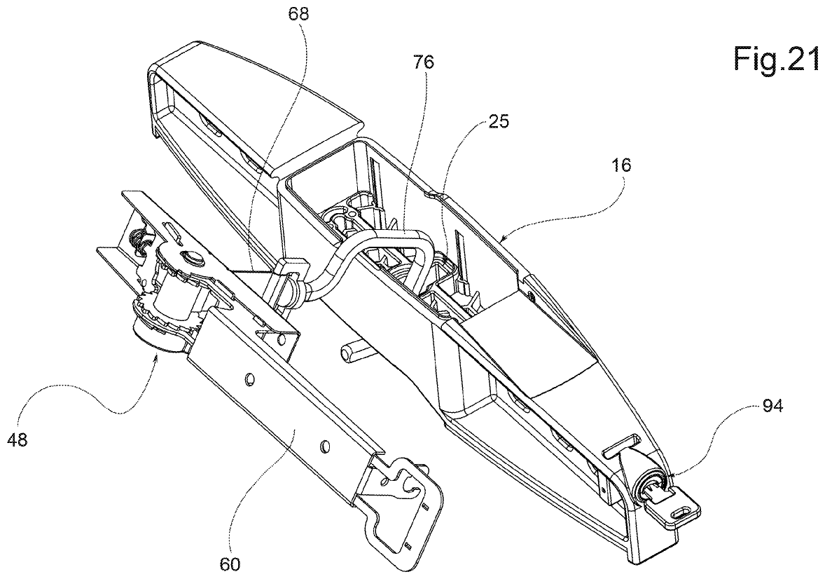

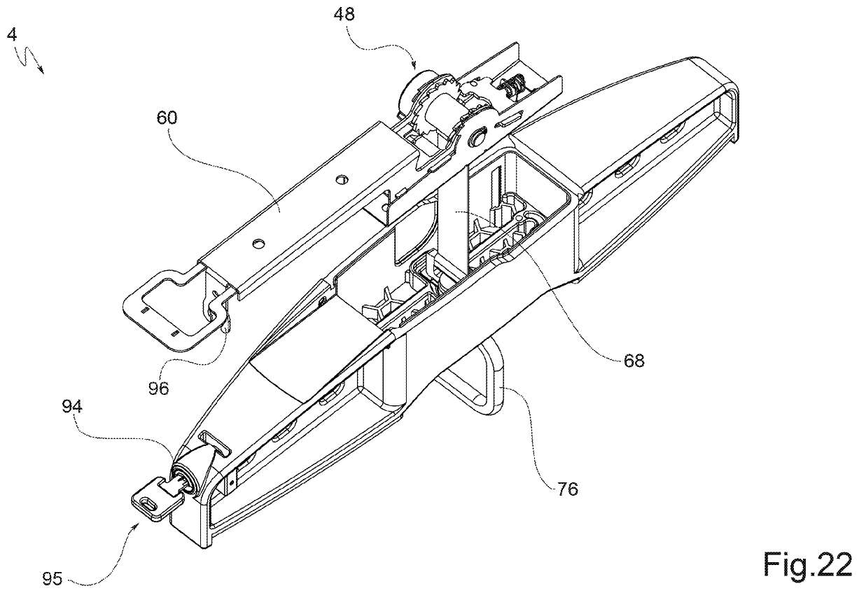

In particular, it begins with the step of preassembling the actuation lever 60 with the spool 48 and the relative flexible locking means 68, which ends with the locking buckle or locking hook 76 on the elongated main body 16, on the side of the upper wall 97 thereof. This operation provides passing the locking buckle or locking hook 76 through the through opening 25 without forcing or stressing. In fact, the through opening 25 is shaped so as to allow the passage of the locking buckle or locking hook 76 (FIGS. 18-22).

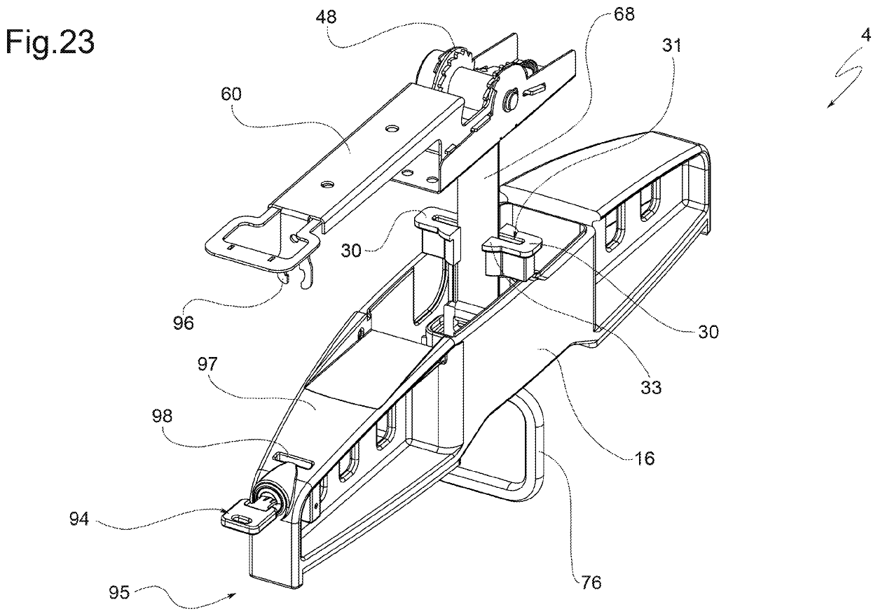

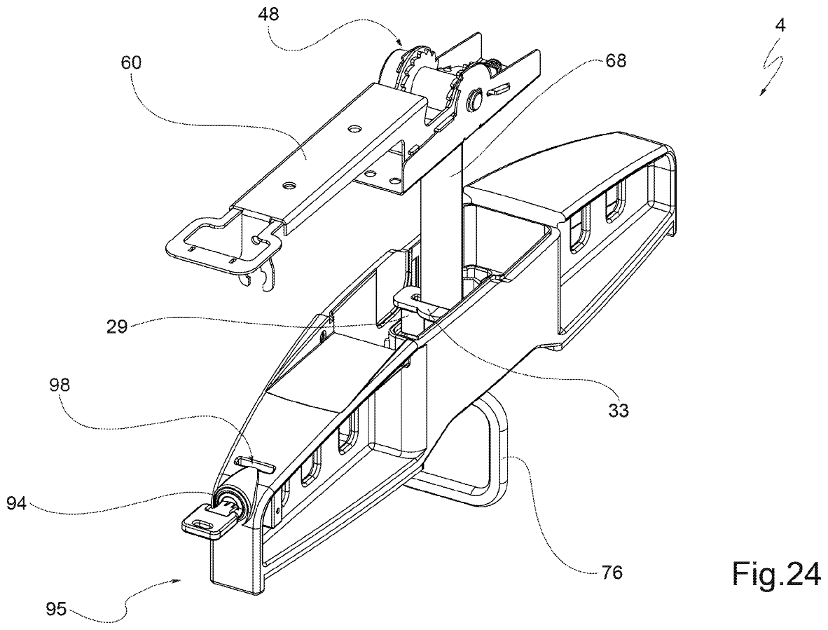

Further, the shells 30 are associated with each other on opposite sides with respect to the flexible locking means 68, until they interlock in the through opening 25, after passing through the through opening 25 with the locking buckle or locking hook 76 (FIGS. 23-24).

The engagement between the shells 30 and the through opening 25 occurs by the abutment of the upper edge 33, which acts as an undercut on the perimeter of the through opening 25.

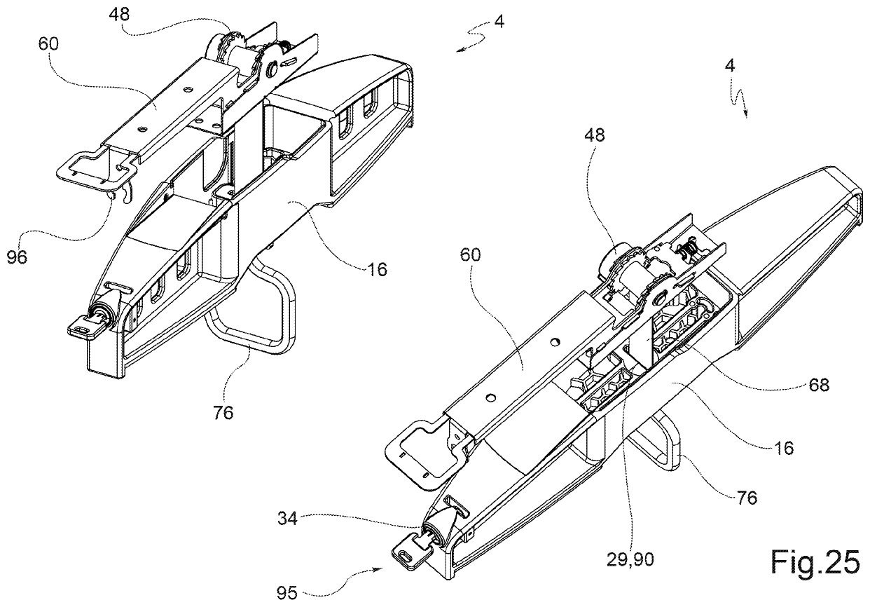

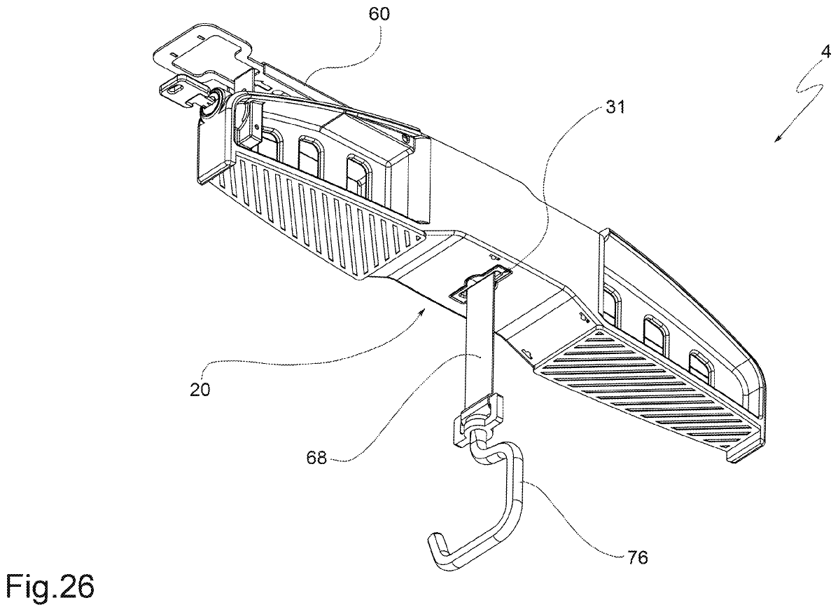

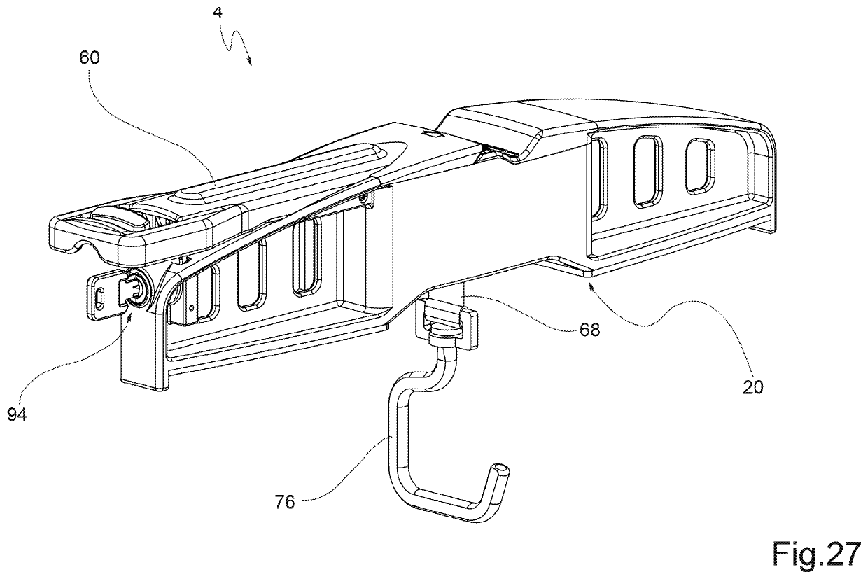

Assembly is therefore easy and may be completed easily even starting from a preassembled spool (FIGS. 25-27).

As can be appreciated from the above description, the present invention allows overcoming the drawbacks introduced in the prior art.

In particular, the ladder clamping device according to the present invention is highly versatile and is adapted to almost all types of ladders on the market since it does not comprise a rigid rod with a rigid hook, rather a flexible and adjustable strap.

Thereby, the negative effects on the aerodynamics of the vehicle, as well as turbulence and undesired noise, are reduced.

There are also no safety risks because there are no rigid cantilevered bodies.

The solution according to the present invention is also particularly ergonomic to use, also by virtue of the locking/unlocking handle.

The use of a locking buckle simplifies assembly and reduces the overall costs of the ladder clamping device. Further, the flexible locking means allow rapid winding around the roof rack bars, regardless of the specific geometry thereof. In other words, flexible means, such as, for example, a strap, are adapted to any section, adhering over almost the entire surface of the roof rack bar, unlike known solutions providing a rigid hook, typically metal.

The assembly of the ladder clamping device is particularly economical, fast, and advantageous by virtue of the fact that it is possible to preassemble the spool assembly and insert it into the main body through the through opening subsequently closed by means of the shells.

In order to meet contingent, specific needs, those skilled in the art may make several changes and variations to the solutions described above.

The scope of protection of the invention is defined by the following claims.

What is claimed is:

1. A ladder clamping device for vehicles, comprising:
an elongated main body, parallel to a longitudinal direction, the elongated main body being provided with a lower wall facing a ladder to be secured,
a ratchet mechanism, housed in the elongated main body and comprising a spool rotatable about a rotation axis perpendicular to the longitudinal direction, the spool being provided with an external toothing and a return spring,
the ratchet mechanism being mechanically connected to an actuation lever protruding from the elongated main body and parallel to the longitudinal direction, the actuation lever being configured to actuate a rotation of the spool, overcoming a resistance of the return spring, and
flexible locking means for the ladder fastened to the spool at a first end thereof and provided with a locking buckle and/or a locking hook at a second end, opposite to the first end,
the flexible locking means being at least partially wound on the spool so as to wind and unwind in agreement with a rotation direction of the spool,
wherein the return spring returns the spool in rotation according to a winding direction of the flexible locking means.

2. The ladder clamping device for vehicles of claim 1, wherein the spool is associated with at least a first stop normally engaged on an external toothing and shaped so that, when in an engagement condition, the first stop makes the actuation lever integral with the spool rotatable in the winding direction of the flexible locking means and allows the rotation of the spool in the winding direction of the flexible locking means.

3. The ladder clamping device for vehicles of claim 2, wherein the first stop is biased into abutment against the external toothing by a first spring, and wherein the actuation lever is provided with a locking/unlocking element, operatively connected to the first stop, so as to allow a transition of the first stop from the engagement condition to a disengagement condition with respect to the external toothing.

4. The ladder clamping device for vehicles of claim 3, wherein the locking/unlocking element is a movable slider that allows a disengagement of the first stop from the external toothing, and wherein the movable slider is part of a plate that is integral with the first stop.

5. The ladder clamping device for vehicles of claim 2, wherein the spool is provided with a second stop always engaged with the external toothing, in agreement with the first stop, and wherein the second stop is biased into abutment against the external toothing by a second spring.

6. The ladder clamping device for vehicles of claim 5, wherein the second stop is arranged in a position diametrically opposite to the first stop.

7. The ladder clamping device for vehicles of claim 1, wherein the actuation lever is provided with a lock for locking the actuation lever on the elongated main body.

8. The ladder clamping device for vehicles of claim 7, wherein the lock is arranged on a lateral end of the elongated main body, wherein the actuation lever is integral with a closing portion, shaped so that, in a lowered configuration of the actuation lever, the closing portion is aligned with the lock, the lock being configured to lock the closing portion so as to prevent the actuation lever from being lifted, when arranged in a locking or closing configuration.

9. The ladder clamping device for vehicles of claim 8, wherein the elongated main body, at an upper wall thereof, provides a seat adapted to at least partially house the closing portion when the actuation lever is lowered into the closing configuration.

10. The ladder clamping device for vehicles of claim 1, to wherein the return spring is a spiral spring, coaxial to the spool.

11. The ladder clamping device for vehicles of claim 1, wherein the lower wall comprises a central base having a through opening with a slot and a central enlargement, and wherein the central base is associated with a removable cap, at least partially counter-shaped with respect to the through opening so as to reduce a passage lumen overall, and wherein the locking buckle or locking hook is shaped to pass through the through opening of the central base of the elongated main body.

12. The ladder clamping device for vehicles of claim 11, wherein the removable cap is made of two shells that are separable from each other, which, once associated with each other, define a through channel shaped to allow passage and sliding of the flexible locking means and to prevent passage of the locking buckle or locking hook.

13. The ladder clamping device for vehicles of claim 12, wherein the shells have an upper edge defining an undercut with respect to the through opening, according to a direction of extraction of the shells from inside the elongated main body downwards, towards the ladder.

14. The ladder clamping device for vehicles of claim 1, wherein the lower wall comprises a central base and a pair of lateral recesses, on opposite sides of the central base, along the longitudinal direction, the lateral recesses being retracted with respect to the central base along a vertical direction, perpendicular to the longitudinal direction, so as to define a seat for at least partially housing a portion of the ladder.

15. The ladder clamping device for vehicles of claim 14, wherein the lower wall is at least partially provided with a surface treatment or processing adapted to increase a grip with the ladder, and/or with lateral containment strips.

16. The ladder clamping device for vehicles of claim 1, wherein the flexible locking means for the ladder comprise a strap, a rope, a cable, a chain or similar elements that are at least partially flexible and windable around the spool.

17. A method of assembling a ladder clamping device that includes:
an elongated main body, parallel to a longitudinal direction, the elongated main body being provided with a lower wall facing a ladder to be secured,
a ratchet mechanism, housed in the elongated main body and comprising a spool rotatable about a rotation axis perpendicular to the longitudinal direction, the spool being provided with an external toothing and a return spring,
the ratchet mechanism being mechanically connected to an actuation lever protruding from the elongated main body and parallel to the longitudinal direction, the actuation lever being configured to actuate a rotation of the spool, overcoming a resistance of the return spring, and
flexible locking means for the ladder, fastened to the spool at a first end thereof and provided with a locking buckle and/or a locking hook at a second end, opposite to the first end,
the flexible locking means being at least partially wound on the spool so as to wind and unwind in agreement with a rotation direction of the spool,
wherein the return spring returns the spool in rotation according to a winding direction of the flexible locking means,
the method comprising:
providing, on the lower wall, a through opening having a slot and a central enlargement,
preassembling the actuation lever with the spool and the flexible locking means, ending with the locking buckle or locking hook, on the elongated main body, on a side of an upper wall of the elongated main body, and
passing the locking buckle or locking hook through the through opening without forcing or effort.

18. The method of claim 17, further comprising:
providing a removable cap, at least partially counter-shaped with respect to the through opening so as to reduce a passage lumen overall, wherein the locking buckle or locking hook is shaped to pass through the through-opening of the central base of the elongated main body,
the removable cap comprising two shells, associated with each other on opposite sides with respect to the flexible locking means until the two shells interlock in the through opening, after passing through the through opening with the locking buckle or locking hook.

19. The ladder clamping device of claim 14, wherein the lower wall is associated with a plate or a co-molded portion configured to increase a grip with the ladder.
